(19) United States
(12) Patent Application Publication
(10) Pub. No.: US 2020/0087966 A1
(43) Pub. Date: Mar. 19, 2020

(54) POSITIONABLE HIDDEN HYDRAULIC HINGE

(71) Applicant: NINGBO PENTAGON DAMPER CO., LTD, Ningbo (CN)

(72) Inventor: Fuyong CAI, Ningbo (CN)

(21) Appl. No.: 16/694,701

(22) Filed: Nov. 25, 2019

Related U.S. Application Data
(63) Continuation of application No. PCT/CN2018/114001, filed on Nov. 5, 2018.

(30) Foreign Application Priority Data
Dec. 26, 2017 (CN) 201711436729.3

(51) Int. Cl. E05F 3/20; E05F 3/10

(52) U.S. Cl. CPC E05F 3/20; E05F 3/12; E05F 3/104

(57) ABSTRACT

A positionable hidden hydraulic hinge configured for installation of a door is provided. The positionable hidden hydraulic hinge includes a non-movable device body configured to be connectable with a door frame, a rotatable device body configured to be connectable with a door leaf, and a hinge configured to connect the non-movable device body and the rotatable device body. The rotatable device body includes a bearing guiding base having a guiding groove and a hydraulic chamber body. The positionable hidden hydraulic hinge also includes a linkage assembly configured to penetrate throughout the hinge. Two ends of the linkage assembly are configured to pivotably connect with the non-movable device body and an internal mechanism of the rotatable device body, respectively. A first end of the bearing guiding base is fixedly connected with the hinge, and a second end of the bearing guiding base is connected with the hydraulic chamber body.

### CROSS-REFERENCE TO RELATED APPLICATIONS

This application is a continuation of International Application No. PCT/CN2018/114001, filed Nov. 5, 2018, which claims priority to Chinese Patent Application No. 201711436729.3, filed on Dec. 26, 2017, the entire contents of both of which are incorporated herein by reference.

### TECHNICAL FIELD

The present disclosure relates to door body accessories and, more particularly, to a positionable hidden hydraulic hinge configured to connect a door leaf with a door frame.

### BACKGROUND TECHNOLOGY

The accessory that connects the door leaf with the door frame and that has an automatic door closing function is referred to as a door closer. Currently, the door closer used for a room door is often installed at the back of the room door, which is also referred to as an exposingly installed door closer, such as a damping hinge disclosed in patent number 201610744065 published by the Chinese national patent office. The disadvantages of such a door closer include: 1. not aesthetically pleasing, and tending to ruin the overall effect of the room door; 2. an exposed part of such type of a door closer has a safety risk for a child in the family; 3. the room door is often not fully closed due to design issues. On the other hand, traditional mechanical hinges, although installed in a hidden manner, cannot achieve the effect of gradual door closing, and do not have a positioning function. It is very inconvenient to use when the door cannot be positioned after being opened. In the current market, although some hydraulic hinges have a hydraulic buffer function, they are all designed for exposed installations, with the hydraulic part configured in a shaft, and the hinge shaft is relatively thick and large. Such a configuration not only has a complex structure, and a short lifetime, but also affects the aesthetics of the door and does not provide a certain degree of fire retardance.

### SUMMARY

The main technical issue to be addressed by the present disclosure is, to provide a positionable hidden hydraulic hinge, which has a simple structure, and is safe to use.

To solve the above technical issues, the present disclosure provides a positionable hidden hydraulic hinge, which includes a non-movable device body configured to be connectable with a door frame, a rotatable device body configured to be connectable with a door leaf, and a hinge configured to connect the non-movable device body and the rotatable device body. The positionable hidden hydraulic hinge also includes a linkage assembly. A positioning mechanism and a hydraulic pressure-resisting mechanism are disposed inside the rotatable device body. The linkage assembly is configured to penetrate throughout the hinge to respectively pivotably connect, at two ends, with the non-movable device body and an inner mechanism of the rotatable device body.

In some embodiments, the non-movable device body and the rotatable device body are configured to be respectively buried (or concealed) in the door frame and the door leaf.

In some embodiments, a positionable hidden hydraulic hinge of the present disclosure includes a hinge, a non-movable device body configured to be connectable with the hinge, and a rotatable device body and a linkage assembly configured to be connectable with the hinge. The non-movable device body and the rotatable device body are configured to be respectively buried in a side edge frame of the room door and a corresponding door frame of the room door. The rotatable device body is provided with a positioning mechanism and a hydraulic pressure-resisting mechanism. The linkage assembly is configured to be connectable with the non-movable device body and the rotatable device body.

In some embodiments, the non-movable device body includes a curved rod fixing base, the curved rod fixing base is configured to be fixedly connectable with the hinge.

In some embodiments, the rotatable device body includes a bearing guiding base, and a hydraulic chamber body. The bearing guiding base is configured to be fixedly connectable with the hinge. The hydraulic chamber body is configured to be fixedly connectable with the bearing guiding base. An interior of the hydraulic chamber body is provided with an end cover of the chamber body, a sealing sleeve of a piston rod, a piston, and a spring.

In some embodiments, the linkage assembly includes a curved rod, a connecting rod, and a bearing. The curved rod is configured to be connectable with the curved rod fixing base through a pin. The connecting rod is configured to be connectable with the curved rod through a pin. Two connecting ends of the connecting rod and the curved rod are respectively provided with a bearing.

The advantages of the present disclosure include: a positionable hidden hydraulic hinge includes a non-movable device body configured to be connectable with a door frame, a rotatable device body configured to be connectable with a door leaf, and a hinge configured to be connectable with the non-movable device body and the rotatable device body. The positionable hidden hydraulic hinge also includes a linkage assembly. A positioning mechanism and a hydraulic pressure-resisting mechanism are disposed inside the rotatable device body. The linkage assembly is configured to penetrate throughout the hinge to respectively pivotably connect, at two ends, with the non-movable device body and an inner mechanism of the rotatable device body. The disclosed structure is simple and compact, convenient for hidden installation, and safe to use.

### BRIEF DESCRIPTION OF THE DRAWINGS

FIG. 1 is a cross-sectional view of an embodiment of the present disclosure;

FIG. 2 is an exploded view of the embodiment shown in FIG. 1;

FIG. 3 is a schematic view of an operation state (door half opened) of the embodiment shown in FIG. 1;

FIG. 4 is a schematic view of an operation state (door opened at 90 degrees) of the embodiment shown in FIG. 1;

FIG. 5 is a cross-sectional view of another part of FIG. 4; and

FIG. 6 is a schematic view of an inner structure of a bearing guiding base of an embodiment.

### DETAILED DESCRIPTION OF THE EMBODIMENTS

Next, the present disclosure will be explained in detail through specific embodiments in combination with the accompanying drawings.

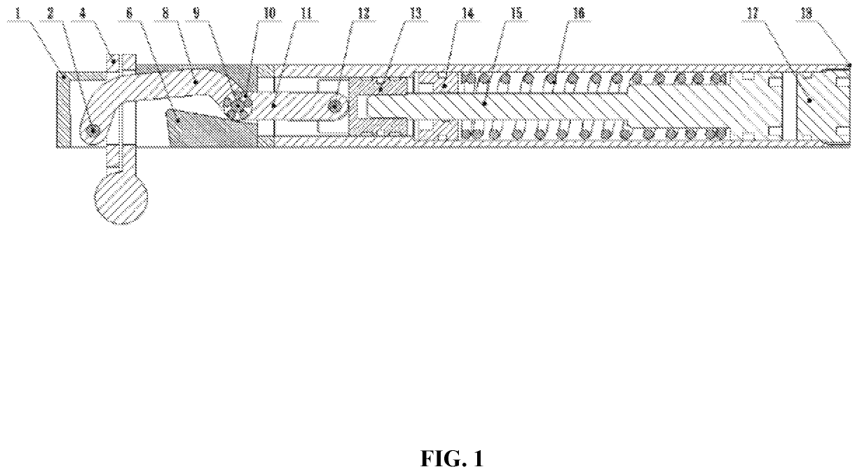

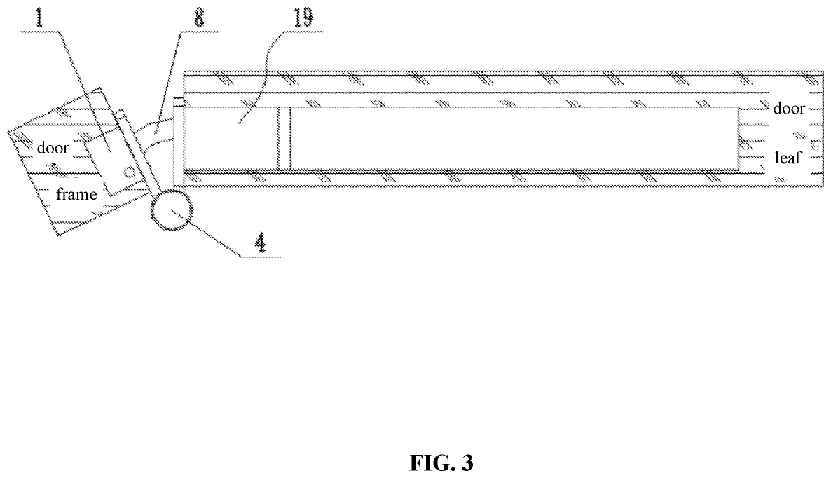

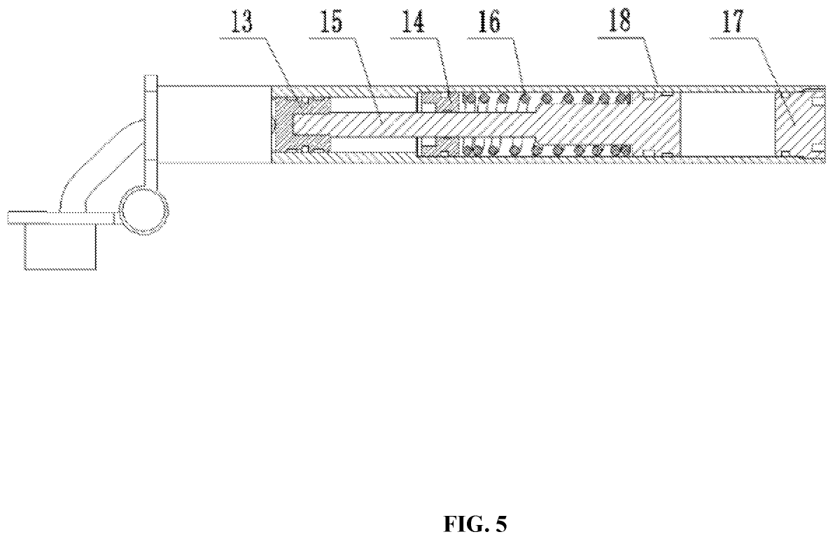

Referring to FIG. 1 to FIG. 6, which show a positionable hidden hydraulic hinge, including a non-movable device body configured to be connectable with a door frame, a rotatable device body 19 (as shown in FIG. 3) configured to be connectable with a door leaf, and a hinge 4 configured to be connectable with the non-movable device body and the rotatable device body 19. The positionable hidden hydraulic hinge also includes a linkage assembly 8. A positioning mechanism and a hydraulic pressure-resisting mechanism are disposed inside the rotatable device body 19. The linkage assembly 8 is configured to penetrate throughout the hinge 4 to respectively pivotably connect, at two ends, with the non-movable device body and an inner mechanism of the rotatable device body 19.

During implementation, as shown in FIG. 3, the non-movable device body and the rotatable device body 19 are respectively buried in a door frame and a door leaf to achieve hidden or concealed installations.

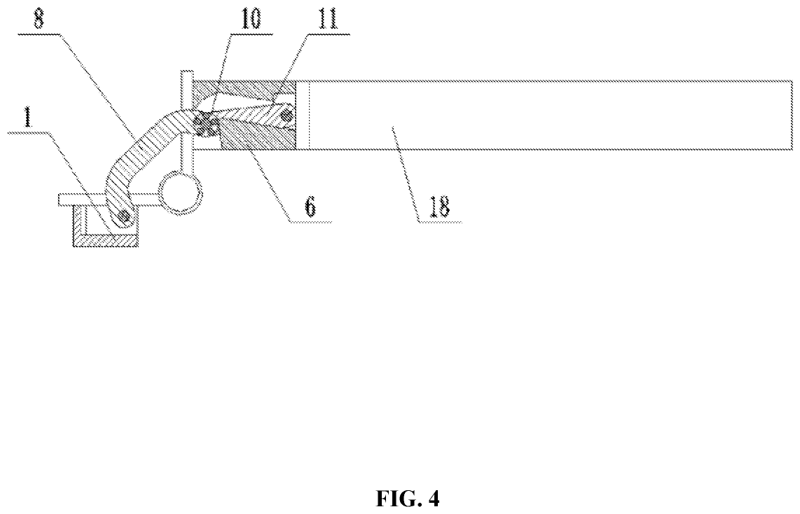

As shown in FIG. 4, the linkage assembly 8 may include a curved rod and a connecting rod 11 that are pivotably connected with one another. The non-movable device body may be a curved rod fixing base 1. The curved rod portion of the linkage assembly 8 may be pivotably connected with the curved rod fixing base 1.

As shown in FIGS. 1, 2, 4, and 6, when implemented, the rotatable device body 19 may include a bearing guiding base 6 having a guiding groove 61, and a hydraulic chamber body 18. An end of the bearing guiding base 6 may be fixedly connected with the hinge 4, the other end may be connected with the hydraulic chamber body 18. A middle segment of the linkage assembly 8 may be embedded in the bearing guiding base 6. A portion of the connecting rod 11 that is pivotably connected with the curved rod may be located in the guiding groove 61 of the bearing guiding base 6 and may be subject to a guiding function thereof. The other end of the connecting rod may be connected with the hydraulic chamber body 18.

As shown in FIGS. 1, 2, 4, and 6, when implemented, the linkage assembly 8 may specifically include a curved rod, the connecting rod 11, a bearing 10, and a pin 9. The curved rod may be pivotably connected with the connecting rod 11 through the pin 9. At both ends of the pin 9, bearings 10 are mounted at an external side of the curved rod. The bearing 10 may cooperate with the guiding groove 61 of the bearing guiding base 6, thereby generating a guiding function to the portion of the connecting rod 11 that is pivotably connected with the curved rod.

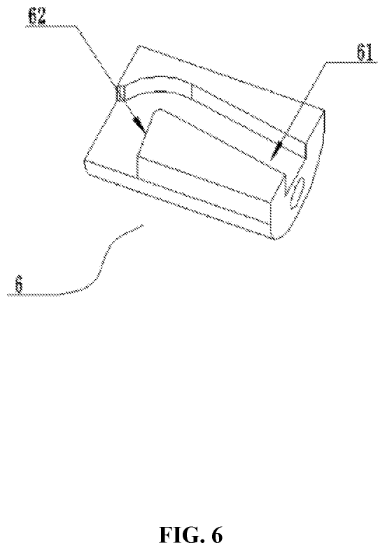

As shown in FIGS. 4 and 6, when implemented, the guiding groove 61 of the bearing guiding base 6 may also include a stepped surface 62 facing the direction of the curved rod fixing base 1. The stepped surface 62 may form a 60° -90° angle with a main body portion of the guiding groove 61.

As shown in FIGS. 1, 2, and 5, when implemented, an interior of the hydraulic chamber body 18 may be provided with: a piston rod sealing sleeve 14, a piston rod 15 having a piston, and a spring 16. After a main body of the piston rod 15 is sleeve-fit with the spring 16, an end of the rod body of the piston rod 15 may penetrate the piston rod sealing sleeve 14 to pivotably connect with the connecting rod 11. Under the pulling action of the connecting rod 11, the piston rod 15 may slide toward an external side of the piston rod sealing sleeve 14 while compressing the spring 16.

As shown in FIGS. 1, 2, and 5, when implemented, a chamber body end cover 17 may also be included. An external end portion of the hydraulic chamber body 18 may achieve sealing through coupling with the chamber body end cover 17.

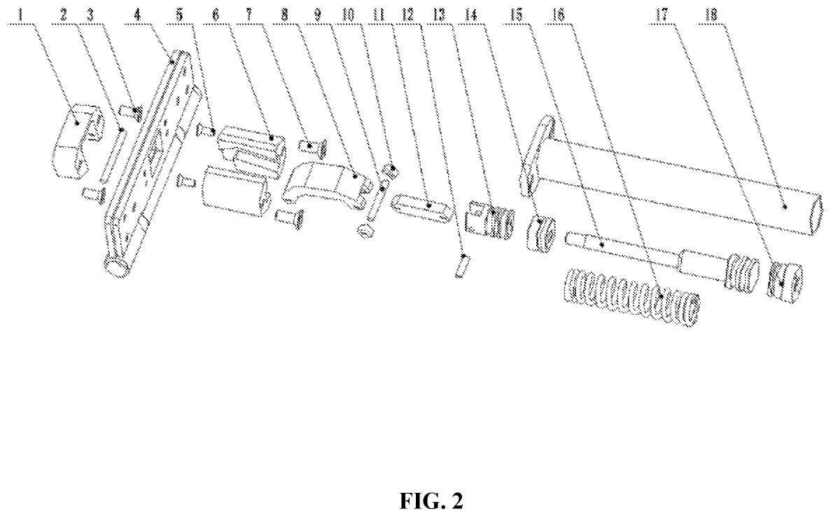

As shown in FIGS. 1 and 2, when implemented, a piston rod nut 13 may be disposed between the connecting rod 11 and the piston rod 15. An end of the piston rod nut 13 may be pivotably connected with the connecting rod 11, the other end may be fixedly connected with the piston rod 15.

As shown in FIG. 1, when implemented, a resistant fluid (e.g., oil) may fill an inside of the hydraulic chamber body 18.

As shown in FIGS. 1 and 2, when implemented, the curved rod may be pivotably connected with the curved rod fixing base 1 through a pin 2. The piston rod nut 13 may be pivotably connected with the connecting rod 11 through a pin 12.

As shown in FIGS. 1 and 2, when implemented, the hinge 4 and the curved rod fixing base 1 may be connected through a screw 3. The hinge 4 may be connected with the bearing guiding base 6 through a screw 5. The bearing guiding base 6 and the hydraulic chamber body 18 may be connected with a screw 7.

In a positionable hidden hydraulic hinge of the present disclosure, when implemented, as shown in FIGS. 3, 4, 5, and 6, the curved rod fixing base 1 may be securely mounted in a door frame, and fixed through the hinge 4. The rotatable device body 19 may be securely mounted in a door leaf, and fixed through the hinge 4. When the door is opened, the curved rod fixing base 1 may cause the linkage assembly 8 (including a curved rod and the connecting rod 11 pivotably connected to a tail portion of the curved rod) to move along the guiding groove 61 on the bearing guiding base 6. The linkage assembly 8 may cause the piston rod nut 13 disposed inside the hydraulic chamber body 18 to move. The piston rod nut 13 may cause the piston rod 15 to move and to compress the spring 16 disposed at an upper end of the piston rod 15. When the linkage assembly 8 moves along with the opening of the door, the bearing 10 on the linkage assembly 8 may move upwardly until reaching the stepped surface 62 disposed at the tail portion of the guiding groove 61, to block the reciprocating movement of the linkage assembly 8, thereby achieving the positioning function. When the door is closed, the door is subject to an external force that pushes the door, which may cause the linkage assembly 8 to move, such that the bearing 10 on the linkage assembly 8 may be pushed off from the stepped surface 62 disposed at the tail portion of the guiding groove 61. At this moment, the compressed spring 16 may push the piston rod 15 to move. The piston rod 15 may cause the piston rod nut 13 to move. The piston rod nut 13 may cause the linkage assembly 8 to move along the guiding groove 61 disposed on the bearing guiding base 6. The linkage assembly 8 may cause the curved rod fixing base 1 to move such that the door is closed. When the door is closed, in the meantime, the piston (which is an end portion of the piston rod 15) inside the hydraulic chamber body 18 may move to generate a hydraulic resistance, such that the door can stably and gradually close.

The disclosed structure can achieve a hydraulic, internally disposed, hidden hinge that is positionable, which can automatically close the door, and which has a hydraulic buffer. Compared to existing technologies, because the presently disclosed device can be installed in a concealed or hidden manner, the overall effect of the room door installation is significantly enhanced. The structure is simple, reasonable, and the device performance is stable, the lifetime is long, and the cost is low. The device of the present disclosure is positionable, can automatically close the door, has a hydraulic buffer for anti-wind and anti-hand jamming, has a stable performance, long lifetime, and is useful and durable.

The above content is a further detailed description of the present disclosure with reference to specific embodiments. This cannot be interpreted as indicating that the specific embodiments of the present disclosure are only limited to these descriptions. A person having ordinary skills in the art can perform simple derivation or substitution without departing from the principle of the present disclosure, which should be regarded as being within the scope of protection of the present disclosure.

What is claimed is:

1. A positionable hidden hydraulic hinge, comprising:
a non-movable device body configured to be connectable with a door frame;
a rotatable device body configured to be connectable with a door leaf, the rotatable device body including:
a bearing guiding base having a guiding groove; and
a hydraulic chamber body;
a hinge configured to connect with the non-movable device body and the rotatable device body; and
a linkage assembly configured to penetrate throughout the hinge, wherein two ends of the linkage assembly are configured to pivotably connect with the non-movable device body and an internal mechanism of the rotatable device body, respectively,
wherein a first end of the bearing guiding base is fixedly connected with the hinge, and a second end of the bearing guiding base is connected with the hydraulic chamber body.

2. The positionable hidden hydraulic hinge of claim 1, wherein the linkage assembly includes a curved rod and a connecting rod that are pivotably connected, wherein the non-movable device body is a curved rod fixing base, and wherein the curved rod of the linkage assembly is pivotably connected with the curved rod fixing base.

3. The positionable hidden hydraulic hinge of claim 2,
wherein the hinge includes two rotatable parts,
wherein the linkage assembly includes a curved rod and a connecting rod that is pivotably connected with the curved rod, and
wherein the curved rod is configured to penetrates holes provided on the two parts of the hinge.

4. The positionable hidden hydraulic hinge of claim 2,
wherein a middle segment of the linkage assembly is embedded in the bearing guiding base,
wherein a portion of the connecting rod that is pivotably connected with the curved rod is located in the guiding groove of the bearing guiding base and is configured to move along the guiding groove, and
wherein an end of the connecting rod is connected with the hydraulic chamber body.

5. The positionable hidden hydraulic hinge of claim 4,
wherein the linkage assembly also includes a bearing and a pin,
wherein the curved rod is pivotably connected with the connecting rod through the pin,
wherein each external side of two ends of the pin is respectively mounted with the bearing, and
wherein the bearing is coupled with the guiding groove of the bearing guiding base to form the guiding function for the portion of the connecting rod pivotably connected with the curved rod.

6. The positionable hidden hydraulic hinge of claim 5,
wherein the guiding groove of the bearing guiding base includes a stepped surface facing a direction toward the curved rod fixing base,
wherein a portion of the stepped surface and a main body portion of the guiding groove form a 60° -90° angle.

7. The positionable hidden hydraulic hinge of claim 4,
wherein an interior of the hydraulic chamber body is provided with: a piston rod sealing sleeve, a piston rod having a piston, and a spring,
wherein a main body of the piston rod is sleeve fit with the spring,
wherein an end of the piston rod is configured to penetrate the piston rod sealing sleeve to pivotably connect with the connecting rod,
wherein the piston rod is configured to slide toward an external side of the piston rod sealing sleeve while compressing the spring under a pulling action of the connecting rod.

8. The positionable hidden hydraulic hinge of claim 7, further comprising:
a chamber body end cover,
wherein an external end portion the hydraulic chamber body is configured to couple with the chamber body end cover to achieve sealing.

9. The positionable hidden hydraulic hinge of claim 7,
wherein a piston rod nut is provided between the connecting rod and the piston rod,
wherein an end of the piston rod nut is pivotably connected with the connecting rod, the other end of the piston rod nut is fixedly connected with the piston rod, and
wherein the hydraulic chamber body is filled with a resistant fluid.

10. The positionable hidden hydraulic hinge of claim 9,
wherein an end of the curved rod is pivotably connected with the curved rod fixing base through a pin, and the piston rod nut is pivotably connected with the connecting rod through a pin.

11. The positionable hidden hydraulic hinge of claim 7,
wherein the spring is located between the piston rod sealing sleeve and an end of the piston rod that is opposite the end of the piston rod pivotably connected with the connecting rod.

12. The positionable hidden hydraulic hinge of claim 1,
wherein the non-movable device body and the rotatable device body are respectively buried in a door frame and a door leaf.
